(19) United States
(12) Patent Application Publication
(10) Pub. No.: US 2017/0091152 A1
(43) Pub. Date: Mar. 30, 2017

(54) GENERATING GRID LAYOUTS WITH MUTABLE COLUMNS

(71) Applicant: ADOBE SYSTEMS INCORPORATED, SAN JOSE, CA (US)

(72) Inventors: DAMIEN ANTIPA, ALSACE (FR); ANTONIO SANSO, DUGGINGEN (CH); GABRIEL WALT, SAN JOSE, CA (US)

(21) Appl. No.: 14/871,707

(22) Filed: Sep. 30, 2015

(51) Int. Cl. G06F 17/21; G06F 17/27; G06F 17/22

(52) U.S. Cl. CPC G06F 17/212; G06F 17/218; G06F 17/2247; G06F 17/2288; G06F 17/227; G06F 17/272

(57) ABSTRACT

Embodiments of the present disclosure relate to generating adaptive grid layouts, for example, for webpages or application pages (i.e., content pages). In this regard, a content page with a grid layout can adapt its presentation, including various properties of its grid layout, for various displaying devices having different characteristics. As such, the content page is presented to users with a suitable layout even while presented via various display devices. In implementation, breakpoints are used to delineate different screen sizes or ranges of screen sizes. The grid layout can be rendered differently in association with different breakpoints.

### BACKGROUND

As webpages evolve from simple HyperText Markup Language (HTML) documents into complex and interactive applications, tools for document layout have become more advanced. For document layout, authors may use a grid layout to divide up a design and place content into the grid. For instance, authors can precisely position and size different elements of a webpage into grid areas defined by columns. Such document layout tools, however, may result in counter-intuitive or undesirable behavior as the display space changes. In this regard, conventional document layout tools, such as floats, may result in undesirable behavior when webpages are to be displayed on different devices with different screen sizes. For example, even with a grid layout, the components floating in a grid can still vary with the size of the screen or the specific resolution of the screen. As users oftentimes use heterogeneous computing devices and generally desire to view an optimal presentation regardless of the unique properties of the viewing device (e.g., screen size or resolution), inconsistent or disruptive presentation of a same webpage can be inefficient and undesired by a user.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the figures of the accompanying drawings.

FIG. 1 is a schematic diagram illustrating an example system configuration for generating grid layout, incorporating aspects of the present disclosure, in accordance with various embodiments.

FIG. 2 is a schematic diagram illustrating an example implementation of a server and a client for generating or editing grid layouts, incorporating aspects of the present disclosure, in accordance with various embodiments.

FIG. 3 is a schematic diagram illustrating an example implementation of a layout manager for managing grid layouts, incorporating aspects of the present disclosure, in accordance with various embodiments.

FIG. 4 is a flow diagram of an example process for generating grid layouts, which may be practiced by an example apparatus, incorporating aspects of the present disclosure, in accordance with various embodiments.

FIG. 5 is a flow diagram of an example process for editing grid layouts, which may be practiced by an example apparatus, incorporating aspects of the present disclosure, in accordance with various embodiments.

FIG. 6 is a schematic diagram illustrating an example implementation of user interface for editing grid layouts under various breakpoints, incorporating aspects of the present disclosure, in accordance with various embodiments.

FIG. 7 is a schematic diagram illustrating an example presentation of floating components in a grid layout under various breakpoints, incorporating aspects of the present disclosure, in accordance with various embodiments.

FIG. 8 is a schematic diagram illustrating examples of new line configurations in grid layouts, incorporating aspects of the present disclosure, in accordance with various embodiments.

FIG. 9 is a schematic diagram illustrating some examples of nested grids under various breakpoints, incorporating aspects of the present disclosure, in accordance with various embodiments.

FIG. 10 is a schematic diagram illustrating an example of hiding components under a breakpoint, incorporating aspects of the present disclosure, in accordance with various embodiments.

FIG. 11 is a schematic diagram illustrating an example of varying presentation of components in a grid layout under different breakpoints, incorporating aspects of the present disclosure, in accordance with various embodiments.

FIG. 12 illustrates an example computing device suitable for practicing the disclosed embodiments, in accordance with various embodiments.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different components, modules, blocks, steps, etc., similar to the ones described in this document, in conjunction with other present or future technologies.

Embodiments of the present disclosure relate to generating adaptive grid layouts, for example, for webpages or application pages (i.e., content pages). In this regard, a content page with a grid layout can adapt its presentation, including various properties of its grid layout, for various displaying devices having different characteristics. As such, the content page is presented to users with a suitable layout even while presented via various display devices. This is done by generating grid layouts for content pages suitable to be displayed by various user devices, even with different display sizes or displaying resolutions.

In implementation, breakpoints are used to delineate different screen sizes or ranges of screen sizes. The grid layout can be rendered differently under different breakpoints. As such, a grid layout associated with one breakpoint can be rendered in one manner, while the grid layout can be rendered in another manner when associated with another breakpoint.

Further, as described herein, the present disclosure also allows a non-technical user to edit the grid layout of a content page with a mutable grid layout based on user preferences, such as in a web content management system (WCMS) or enterprise content management system (ECMS), in which a user who has less technical knowledge can access a content management system to update content or even change the grid layout on a content page. By way of example, a user can define the mutation pattern of a component for different breakpoints, or edit various properties of a grid layout under different breakpoints, e.g., via a GUI.

Various terms are used throughout this description. Definitions of some terms are included below to provide a clearer understanding of the ideas disclosed herein.

The phrase “content page” refers to any page that provides content. A content page may be, for example, a web page indicated by a uniform resource locator (URL) or application pages in an application. Generally, a user device requests a content page and, in response, a content page is provided to the user device.

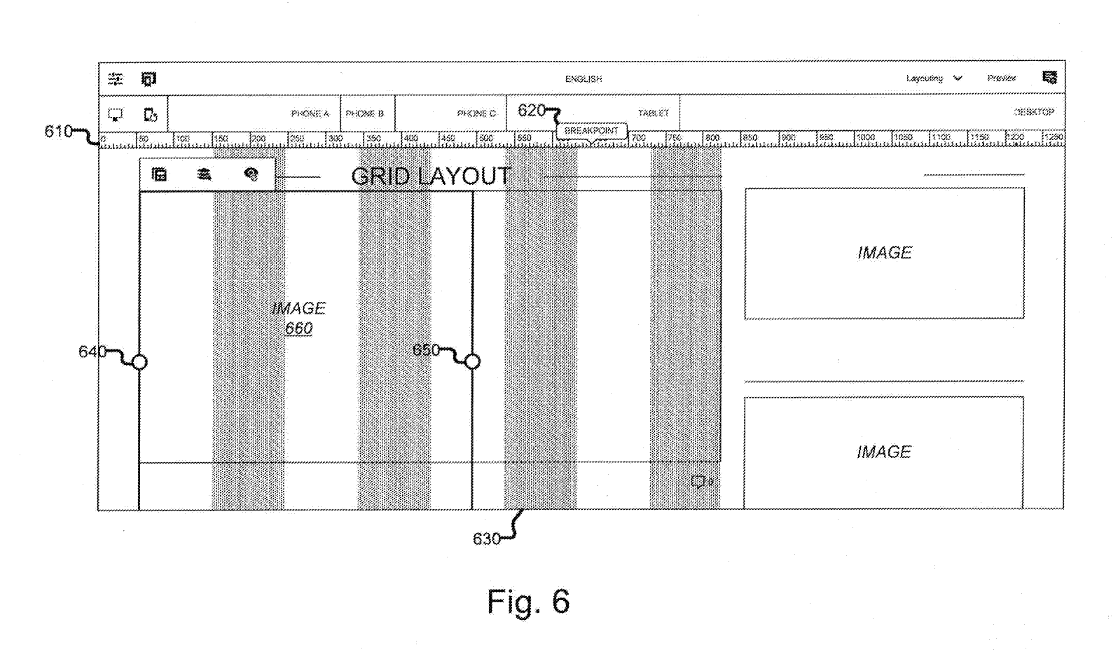

The phrase “grid layout” refers to any configuration that lays out one or more components in a grid structure. Grid layouts are used to organize components within a content page. A grid layout generally includes one or more columns and, in some cases, one or more rows. Although a grid layout is generally illustrated herein as rectangular in shape, a grid may be for other forms. Examples of grid layouts are generally shown in FIGS. 6-11.

A “component” refers to an item of content that can be placed in a grid layout. A component may be text, audio content, graphical content, image, video content, or content in other forms. A component within a grid or a nested grid can react on a selected breakpoint. As an example, the component is to be rendered with different width under different breakpoints, e.g., by changing the number of columns occupied by the component. As a result, the same component can mutate under different breakpoints to adapt its presentation according to the selected breakpoint.

The term “breakpoint” refers to an indication of a boundary condition, e.g., resolution width or screen size, at which the presentation of a grid layout or components therein, (e.g., layout or font size), may change. In this regard, breakpoints are generally defined to delineate different screen sizes or range of sizes that covers various types of screens. The grid layout for a content page can be designed to be rendered differently under different breakpoints such that, for instance, columns mutate in accordance with a breakpoint corresponding with the user device.

Oftentimes, a single webpage is to be accessed by heterogeneous computing devices, e.g., wearable computing devices with miniature screens, smartphones with small screens, laptops computers with medium screens, or desktop computers with large screens. Because users utilize varying computing devices yet desire a consistent presentation of data, designers and content providers generally desire to provide a consistent data presentation, for example, via a webpage. In particular, designers and content providers generally strive to achieve their intended presentation or effect of dynamic and interactive webpages on heterogeneous computing devices with one single design.

To achieve this consistent presentation effect, one solution conventionally implemented enables components to “float” in a grid layout on a webpage, so that the presentation of the webpage can adapt to different computing devices. Generally, grid layouts allow developers to divide up a design into a grid and place content into that grid. However, the present solutions to provide grid layouts for web or application design are limited. As an example, the number of columns in a grid layout cannot dynamically mutate in conventional implementations. As another example, nested grid columns are usually not supported. Furthermore, editing the grid layout usually requires a user to manually change Cascading Style Sheets (CSS) or HyperText Markup Language (HTML) code. Thus, a web content editor, who lacks coding knowledge, may not be able to edit the grid layout of a content page.

The present disclosure discloses methods and systems for generating grid layouts for content pages (e.g., web pages or application pages). In this regard, a content page having a grid layout can adapt its presentation, including various properties of the grid layout, for various displaying devices with different characteristics. As such, the content page is to be presented to users with a localized layout to consume the information. Thus, designers and content providers can achieve their intended presentation or effect of dynamic and interactive webpages on heterogeneous computing devices with one single design.

To enable mutable grid layouts for content pages suitable to be displayed by heterogeneous computing devices, breakpoints are defined to delineate different screen sizes or range of sizes that covers various types of screens. The grid layout for a content page can be designed to be rendered differently under different breakpoints such that, for instance, columns mutate in accordance with a breakpoint corresponding with the user device. A content page may contain various configurations for grid mutation, and the displaying device can select a particular breakpoint, e.g., based on the characteristics of its screen, to present a particular configuration for grid mutation. In some embodiments, the number of columns of the grid mutates according to the selected breakpoint, e.g., based on the screen size. In other embodiments, the number of columns occupied by a component on the content page mutates according to the corresponding breakpoint.

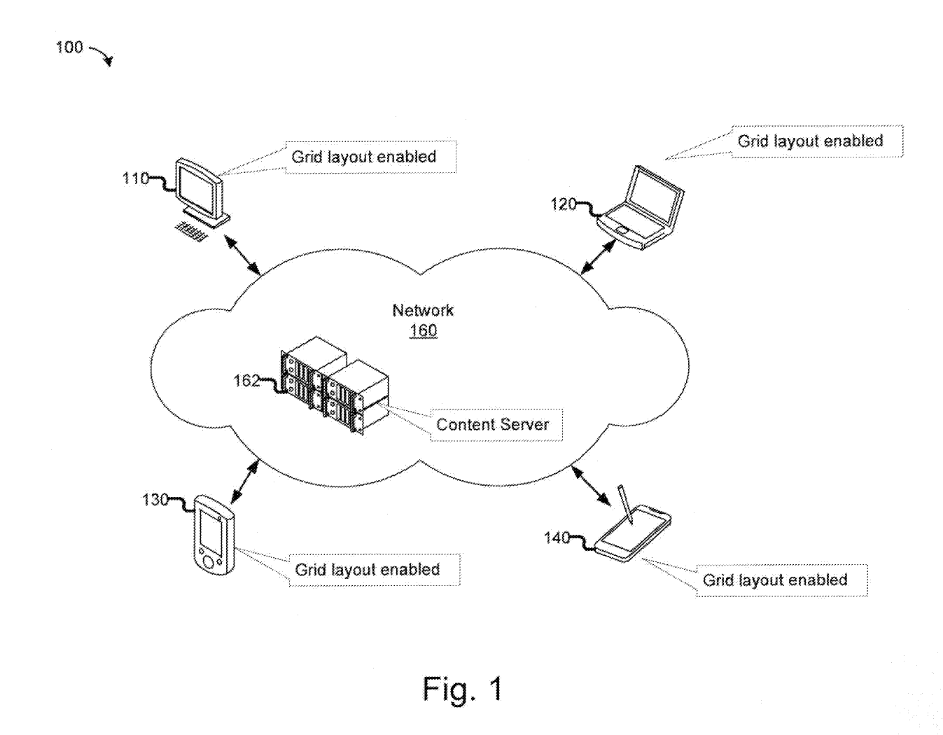

With reference now to FIG. 1, an example system configuration for generating grid layouts, in accordance with various embodiments, is illustrated. System 100 includes various user devices of one or more users that can access a content server(s) in system 100 via a network 160. As illustrated in FIG. 1, user devices includes, e.g., desktop computer 110, mobile computer 120, smartphone 130, or tablet computer 140.

User devices are configured to connect to a server device(s) via network 160, such as content server 162, via wired or wireless connections. As will be described in more detail below, user devices generally display content pages having grid layouts and/or enable editing of grid layouts. The content server 162 is generally configured to generate and/or provide grid layouts for content pages suitable to be displayed by various user devices, even with different display sizes or displaying resolutions.

In operation, and at a high level, various user devices, e.g., mobile computer 120 and smartphone 130, request a content page from content server 162. For example, mobile computer 120 requests a webpage from content server 162 via a common URL, e.g., via an HTTP Get request. In response, content server 162 generates or retrieves a grid layout with mutable columns for the content page. Content server 162 can also declare a number of breakpoints, e.g., in a media query declaration section of the content page, so that the grid layout may mutate its columns based on a selected breakpoint. Content server 162 may also retrieve required components to populate the content page. In some embodiments, a component is represented by a URL so that the requesting device will pull the dynamic content based on the URL of the component. Once the content page is assembled, content server 162 sends the content page to the requesting device.

The user device, which received the content page from content server 162, can present the content page to a user based on a selected breakpoint associated with the user device. As an example, assume mobile computer 120 and smartphone 130 are associated with different breakpoints, and the grid layout of the content page has a directive to mutate the number of columns of the grid layout for these different breakpoints. As a result, smartphone 130 will present fewer columns for the grid than mobile computer 120. As another example, assume the grid layout of the content page has a directive to mutate the number of columns occupied by a component, e.g., an image, based on these breakpoints. As a result, smartphone 130 can allocate more columns to the component than mobile computer 120, so that the image can be presented as a salient feature on the relative small screen of smartphone 120.

In various embodiments, a user device, e.g., desktop computer 110 or tablet computer 140, can enable a user to edit a content page, including its grid layout, via a specially designed user interface. Such a user interface will allow the user to post the modifications to content server 162 via, for example, an HTTP Post request. A user can make various changes to the grid layout in the content page. As an example, a user can change the number of columns in a grid associated with a breakpoint. For instance, a user allocates more columns to a large display breakpoint than a small display breakpoint to take advantage of the greater real estate on a larger display. As another example, a user can change the number of columns occupied by a component. For instance, a user allocates more columns to an image under a small display breakpoint than a large display breakpoint so to make the image more visible on a small display. As yet another example, a user can add, remove, or modify a nested grid in the grid layout. As yet another example, a user can prevent a component from being displayed with a breakpoint, or force the component to be displayed on a new line on the grid layout with the breakpoint.

In response, content server 162 parses the modification request from the user device, e.g., to get the intended number of columns occupied by a component associated with the selected breakpoint, so that content server 162 can update a resource node that corresponds to the component with the intended number of columns. In various embodiments, a resource node is a suitable data structure, accessible to server 162, for storing information of the component.

While not illustrated, user devices in system 100 may also include, an audio and/or video player, a gaming device, a video camera, a digital camera, a navigation device, and/or other suitable user electronic devices, which communicates with cloud 160 and be enhanced with the teachings of the present disclosure to display and/or edit a grid layout, as described herein.

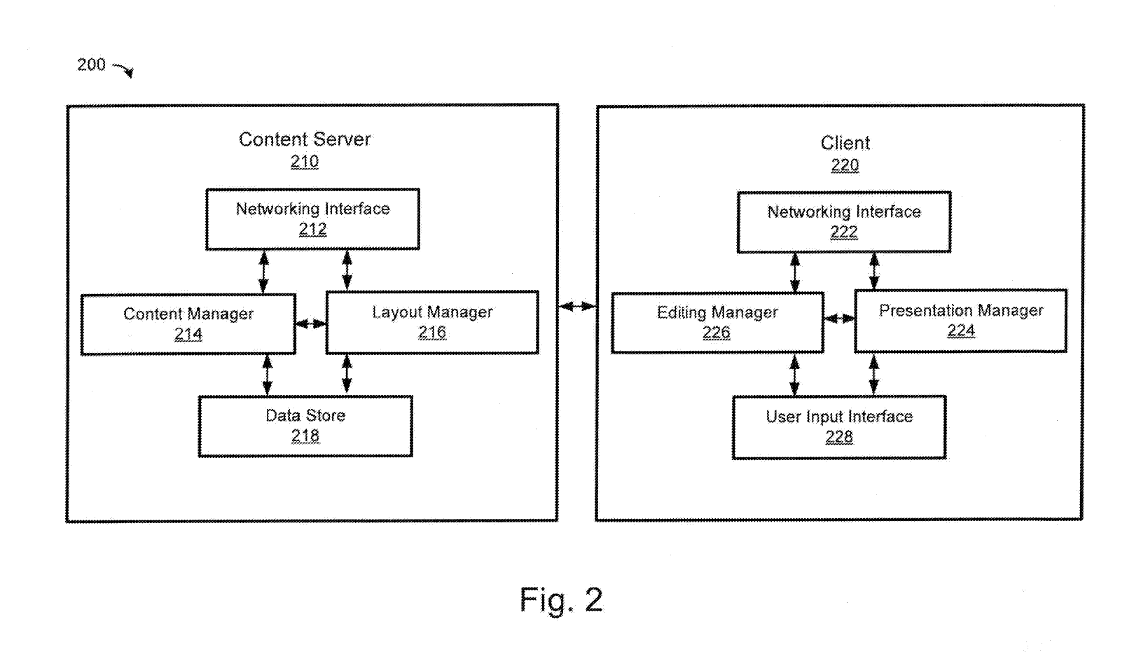

Referring now to FIG. 2, a schematic diagram illustrates an example implementation of a server and a client for generating, providing, viewing, and/or editing grid layouts in accordance with various embodiments. In embodiments, content server 210 may be a server computing device, such as server 162 in FIG. 1. Content server 210 generally generates and/or provides grid layouts with mutable columns for content pages. As illustrated in FIG. 2, content server 210 includes networking interface 212, content manager 214, layout manager 216, and data store 218, operatively coupled with each other. In various embodiments, client 220 is a client computing device, such as mobile computer 120 in FIG. 1. Client 220 generally displays and/or enables editing of a grid layout. As illustrated in FIG. 2, client 220 includes networking interface 222, editing manager 226, presentation manager 224, and user input interface 228, operatively coupled with each other.

In various embodiments, content server 210 generates grid layouts with mutable columns for content pages. A grid layout refers to a configuration that facilitates a layout of one or more components in a grid with one or more columns. As such, a grid layout is used to structure or format various components within a content page. A grid layout may include a nested grid(s), as described in more detail herein. A nested grid generally inherits column properties from its host grid. In some embodiments, such inheritance can be interrupted, e.g., so that the nested grid can have a different number of columns than what has been inherited. When a content page from content server 210 is received by client 220, it can mutate the grid layout based on a corresponding breakpoint, and client 220 may also mutate a selected component inside the grid based on the corresponding breakpoint. On the other hand, when the content page is presented in an editing mode on client 220, the content page can be enabled to allow intuitive editing based on visual tools, e.g., provided under user input interface 228. As a result, a user can dynamically configure rendering behavior of a content page based on breakpoints.

In operation, content server 210 receives a request for a content page from client 220 via networking interface 212. In response, layout manager 216 generates or retrieves a grid layout with mutable columns associated with various breakpoints for the content page. Content manager 214 generally can generate or retrieve, e.g., facilitated by data store 218, various components associated with the content page. Subsequently, server 210 can build the content page by assembling these components according to the grid layout.

The number of columns occupied by a component can vary with different breakpoints. Content manager 214 can specify a particular number of columns occupied by the component associated with a particular breakpoint. Thus, the content page may adapt the component according to one or more characteristics of the client displaying device, e.g., its size, its resolution, or its device type. As an example, although two images share a same line under a breakpoint associated with desktop computers, they can be configured to occupy more columns under another breakpoint associated with smartphones, so that they will be broken into different lines on smartphones.

In various embodiments, the number of columns occupied by a component under a breakpoint are stored together with the component, e.g., in a resource node including the component and its related information. Content manager 214 may be configured to retrieve such information from the resource node. In some embodiments, the columns in a grid have equal width. As an example, the width of every column equals to the width of the grid divided by the number of columns in the grid. In this case, a wider displaying window will show a wider grid and accordingly wider columns.

Sometimes, a component occupying a number of columns cannot be fit into an existing line of components in the grid. When there are not enough columns to fit the component in the present line of components, layout manager 216 can allow the component to naturally flow into the next line. Layout manager 216 can further specify the relative position of a component among its neighboring components on the grid layout. In some embodiments, layout manager 216 specifies an order for a group of components hosted by a grid. As an example, layout manager 216 can enumerate a group of components in an order in the content page. As another example, layout manager 216 can assign an ordinal number to each component in the group. As yet another example, layout manager 216 can specify a prior and a post component for a selected component, so that all components will be linked in an order. As a result, this group of components will flow inside the grid from one line to another based on their order.

In this regard, in accordance with receiving a content page, presentation manager 224 of the client 220 can divide the content page layout into a predefined number of columns according to the grid layout, e.g., generated by layout manager 216. The actual width of the columns is relative to the container in which they are located. Presentation manager 224 places components, e.g., images, video, text, etc., inside the grid layout, and allocates one or more columns to each component, up to the maximum defined number of columns of the grid. In case a component does not have enough space, e.g., fewer columns left in the present line than the number of columns required for the component, presentation manager 224 can perform a line break into the next line.

In other words, presentation manager 224 facilitates all components to be floated and simply pushes them from left to right, or right to left, in some instances. It is analogous to how one normally writes. As an example, we write from left to right, and then break to the next line below the current line when there is no more space to write on the current line.

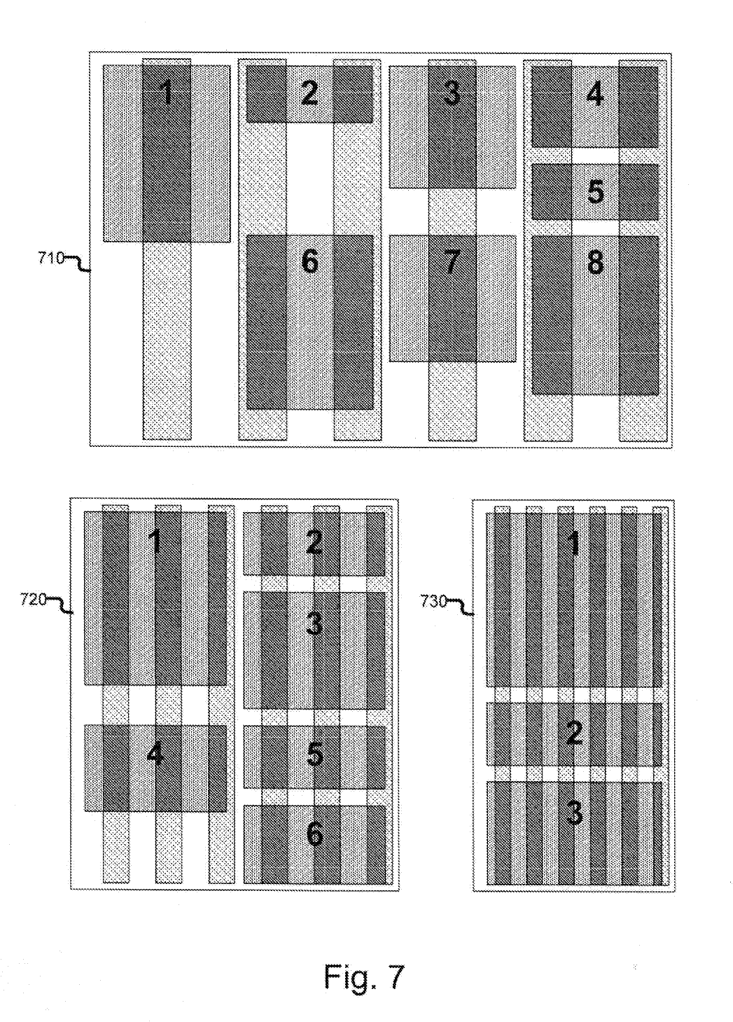

By way of example, FIG. 7 illustrates an example presentation of floating components in a grid layout under various breakpoints. In this example, components 1-8 in grid layout 710 float from left to right within a line, then top to bottom from one line to another line. Similarly, under a different breakpoint associated with grid layout 720, components 1-6 also float from left to right, then from one line to another. Under a different breakpoint associated with grid layout 730, however, as each component occupies all columns in the grid, components 1-3 appear to float vertically. Noticeably, the columns occupied by the same components, e.g., component 1, have mutated under different breakpoints. On grid layout 710, component 1 is allocated with three columns. However, on grid layouts 720 and 730, component 1 is allocated with six columns and twelve columns respectively. By allocating different columns under different breakpoints, the presentation of floating components can vary under different breakpoints.

Returning to FIG. 2, in some implementations, layout manager 216 provides an indication to force a component to be displayed on a new line on the grid layout under a selected breakpoint. In one embodiment, layout manager 216 associates a directive for a new line with the selected component. Thus, the selected component is displayed on a new line. In another embodiment, layout manager 216 associates a condition for a new line with the selected component. As an example, a condition of the margin around the selected component is to be set as a predicate to trigger a new line. For instance, whenever the right margin of the selected component is less than two columns or 100 pixels, the selected component is to be placed to the next new line.

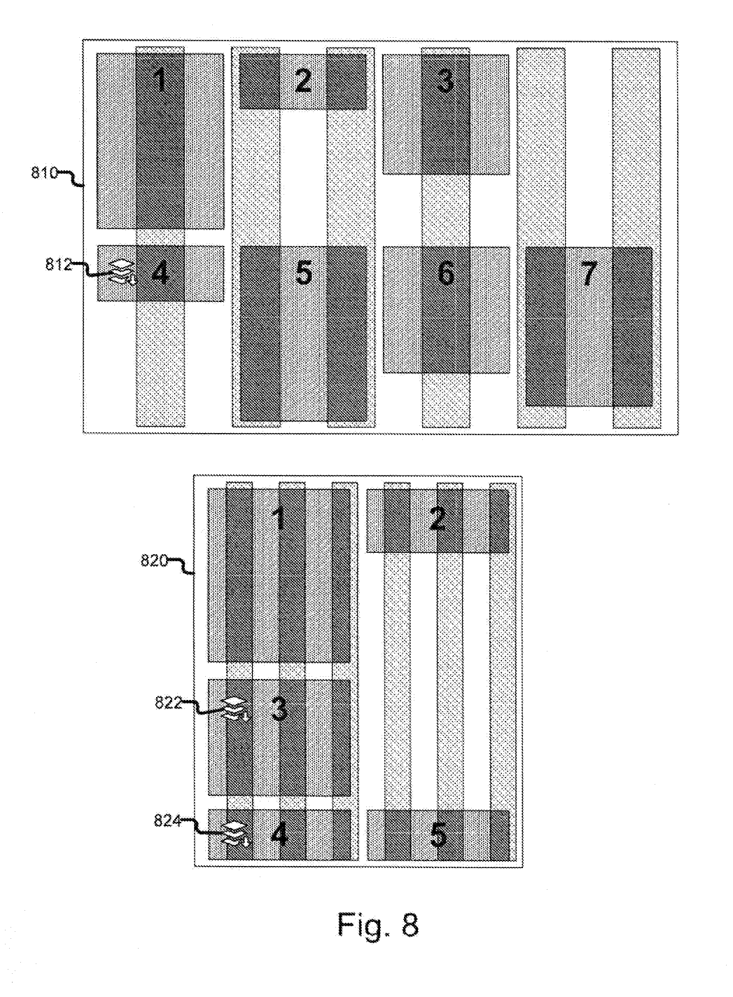

By way of example, and with reference to FIG. 8, FIG. 8 illustrates examples of new line configurations in grid layouts. In one example, layout manager 216 provides new line indication 812 to component 4 on grid layout 810. As a result, although there is sufficient space next to component 3 for component 4 to park, component 4 still breaks into a new line. In another example, layout manager 216 provides new line indication 822 to component 3 and new line indication 824 to component 4 on grid layout 820. As a result, component 3 and component 4 break into their respective new lines. Although new line indications are illustrated as physical icons in FIG. 8, it is conceivable that such new line indication is generally implemented as a line of code associated with a component, and their physical manifestation in FIG. 8 is for the purpose of illustration.

Now referring back to FIG. 2, layout manager 216 may further provide a nested grid in the grid layout. The nested grid generally inherits at least a property associated with the mutable columns of the host grid, e.g., the number of columns. When one grid layout is nested into another, layout manager 216 enables the nested grid to intelligently inherit the allocated columns from the host grid to the nested grid. For instance, if a host grid of 12 columns has a nested grid to occupy the width of 4 columns, then the space allocated to the nested grid will not be divided again by 12 columns, but rather by 4 columns inside the nested grid, which are inherited from its host grid. In this case, a column, whether in a host grid or a nested grid, has a homogenous width. However, in some other embodiments, layout manager 216 can enable the nested grid to break such inheritance, so that the nested grid can have columns with different width compared to the columns of the host grid.

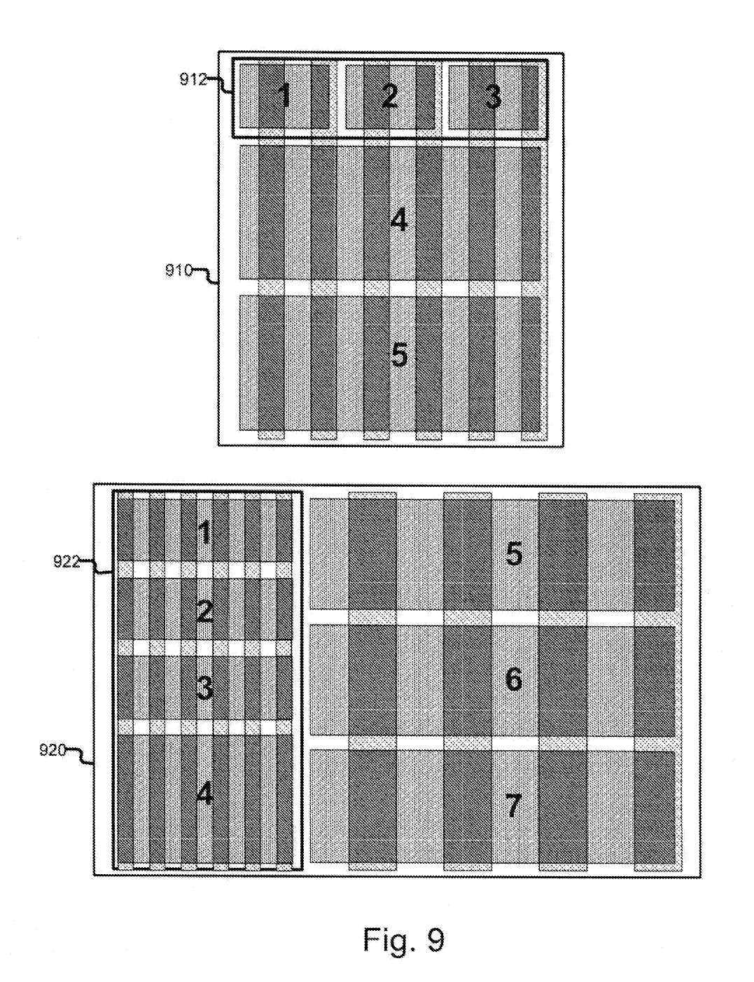

By way of example, FIG. 9 illustrates some examples of nested grids under various breakpoints. On grid layout 910, nested grid 912 is provided to host components 1-3. In this case, nested grid 912 bonds components 1-3 in one unit. If components 1-3 need to be placed in a different location, one may specify the new location for nested grid 912 without specifying the individual location of each components inside nested grid 912. In this embodiment, nested grid 912 inherits the number of columns originally allocated by the host grid, which is 12 columns to be shared by components 1-3.

With respect to grid layout 920, nested grid 922 is provided to host components 1-4. Without nested grid 922, components 1-4 would flow from left to right as described before. However, due to nested grid 922, components 1-4 flows only within nested grid 922. As a result, they appear to flow vertically. In this embodiment, nested grid 922 also break the inheritance with the host grid, so that nested grid 922 has different columns with different width compared to the columns of the host grid, which offers more flexibility to arrange components within nested grid 922.

Now referring back to FIG. 2, in some embodiments, layout manager 216 provides an indication in the content page to prevent a component from being displayed on the grid layout for a selected breakpoint. As an example, some components need to be hidden under a breakpoint associated with smartphones so that the presentation of the content page will not be overcrowded on a small screen. In one embodiment, layout manager 216 associates a list of such stealthy components with the selected breakpoint, and such list can be stored together with the breakpoint. In another embodiment, layout manager 216 associates the indication of hiding under a selected breakpoint with the component, and such indication can be stored together with the component.

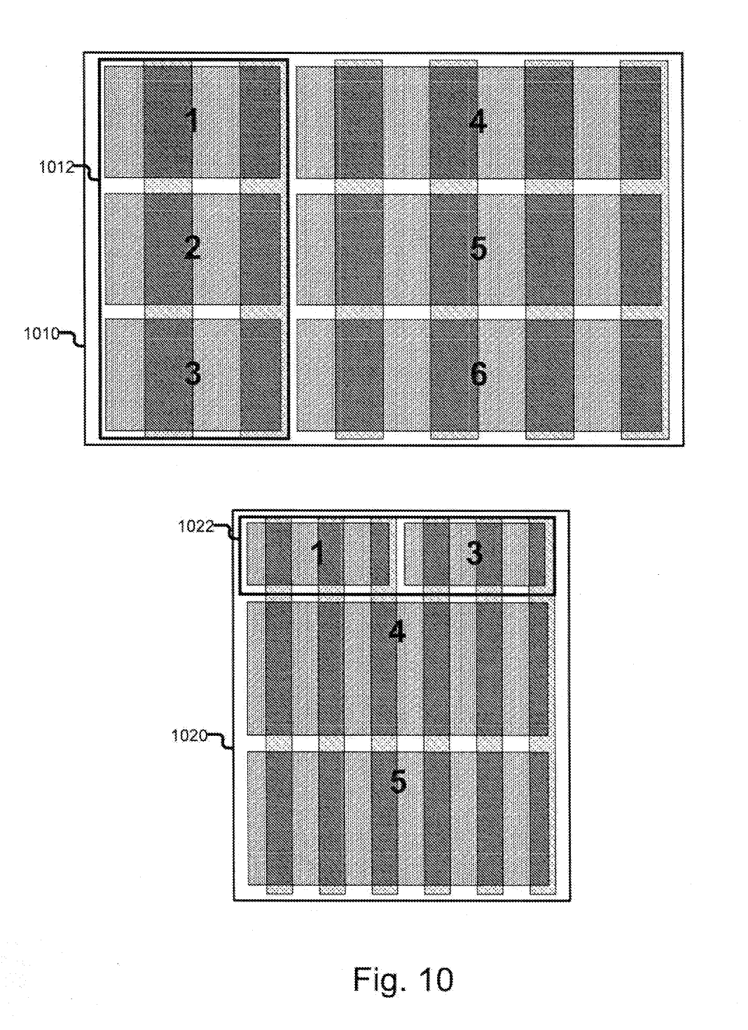

FIG. 10 illustrates an example of hiding components under a breakpoint. As shown with grid layout 1010, components 1-3 are displayed within nested grid 1012. However, an indication to hide associated with component 2 under a different breakpoint associated with grid layout 1020 prevented component 2 from being displayed within nested grid 1022. As one may contemplate, with a narrower screen associated with this breakpoint, nested grid 1022 lacks sufficient space to simultaneously display all three components. By hiding component 2, at least components 1 and 3 are more visible with grid layout 1020.

Returning again to FIG. 2, client 220 can request, display, or edit a content page based on a selected breakpoint. In some embodiments, client 220 requests and receives a content page via networking interface 222. Then, presentation manager 224 presents the content page based on a selected breakpoint pertinent to client 220. A breakpoint may be associated with the size of the screen or the range of sizes that covers a range of different screens. For instance, if there is a breakpoint of the width of 519 pixels or less for a portrait layout with phone devices in the content page, and the screen of client 220 is configured with a resolution of 320 by 1240, then presentation manager 224 will select the breakpoint for the phone devices, and present the content page based on the grid layout under the breakpoint of 519 pixels.

In some embodiments, presentation manager 224 selects a breakpoint corresponding to the actual characteristics of the displaying device. However, in other embodiments, a user can force presentation manager 224 to select a different breakpoint, for example, when the user needs to view a different presentation of the same content page.

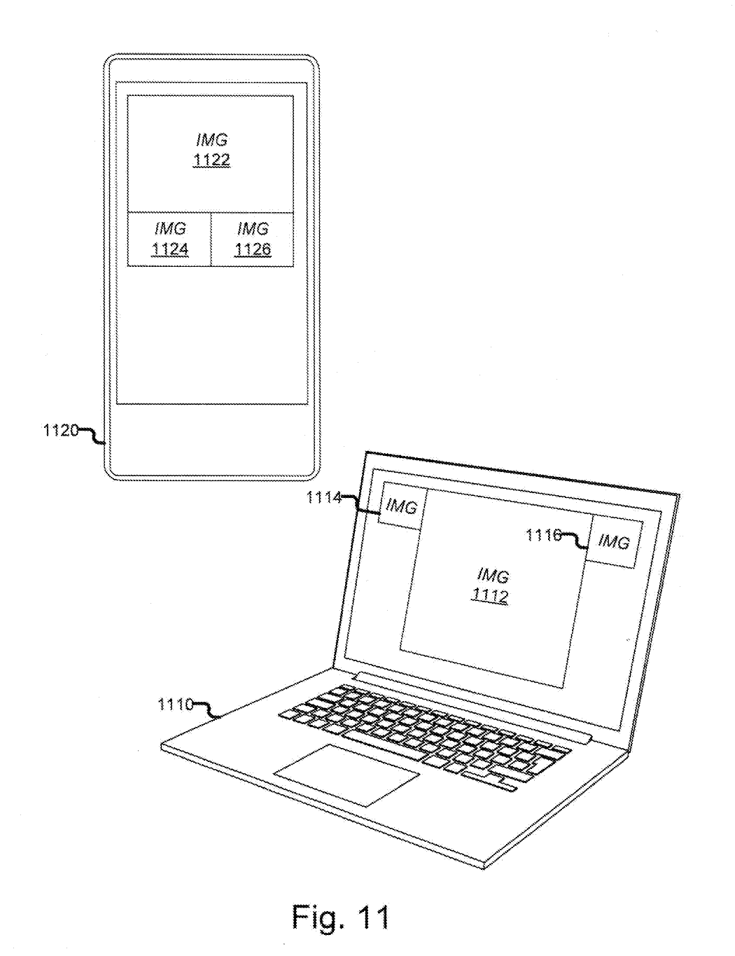

By way of example, and with reference to FIG. 11, FIG. 11 illustrates an example of varying presentation of components in a grid layout under different breakpoints. By way of example, three images are to be presented in a grid. The style sheet specifies that the grid should have 12 columns, which may also be a default setting for a grid. The style sheet related to the first image further specifies “GridColumn—phone—12” and “GridColumn—laptop—2.” Further, the style sheet related to the second image specifies “GridColumn—phone—6” and “GridColumn—laptop—8.” Finally, the style sheet related to the third image specifies “GridColumn—phone—6” and “GridColumn—laptop—2.”

In this case, presentation manager 224 selects a phone breakpoint for phone 1120, and enables the first image to be displayed as image 1122, which occupies the whole 12 columns. Further, the second and third images are displayed as image 1124 and 1126, which share the second line in the grid, and each occupies 6 columns as specified in the style sheet.

Similarly, presentation manager 224 selects the laptop breakpoint for laptop 1110, and lets the first image to be displayed as image 1114, which occupies only 2 columns. Then, the second image flows in the right direction and becomes image 1112, which occupies 8 columns. Finally, the third image appears next as image 1116, which is to occupy the remaining 2 columns in the same line as previous two images.

Now referring back to FIG. 2, in various embodiments, presentation manager 224 presents the content page in an edit mode. Subsequently, user input interface 228 enables a user to edit the content page for a selected breakpoint. As an example, the allocated numbers of columns for a component can be changed by dragging the component to a bigger size, e.g., for the purpose of allowing an image occupy different columns under different breakpoints.

Referring now to FIG. 6, which illustrates an example implementation of user interface for editing grid layouts under various breakpoints. In this embodiment, ruler 610 indicates the screen size of a user device, e.g., the horizontal pixels associated with a display. Different user devices may form different groups of devices, such as a group of type A phones, a group of type B phones, a group of type C phones, a tablet group, or a desktop group. In some embodiments, various devices in a particular group share a common breakpoint. In other embodiments, numerous different breakpoints may be defined within a particular group, such as based on subgroups or the actual screen size.

A user can select a breakpoint by moving breakpoint 620 to a desired position on ruler 610. As illustrated, the user selected a breakpoint in the tablet group. In this example, grid 630 has eight columns, and image 660 is hosted in grid 630. The user may adjust various characteristics of image 660, e.g., by dragging adjusting point 640 or 650 toward left or right. As an example, the user may drag adjusting point 650 in the right direction to allocate additional columns in grid 630 to image 660. Similarly, the user may drag adjusting point 640 in the right direction to reduce the number of columns allocated to image 660. The changes made to image 660 will be stored with image 660 under the selected breakpoint.

Now referring back to FIG. 2, in some embodiments, user input interface 228 communicates a dragging operation on the component under a selected breakpoint to presentation manager 224. Consequently, presentation manager 224 performs a partial refresh of the component to show the layout desired by the user. In some embodiments, user input interface 228 communicates such a dragging operation on the component to editing manager 226. Subsequently, editing manager 226 communicates the intended number of columns occupied by the component to content server 210, e.g., to layout manager 216. In some embodiments, layout manager 216 sends a new markup, with the updated layout, to client 220. Thus, presentation manager 224 can perform a partial refresh of the component. In this case, such modification will be memorized by content server 210, so that the updated layout can be distributed to client 220 in the future. In some embodiments, content server 210 will permanently update the configuration for this particular component under the selected breakpoint. In this case, user input interface 228 and editing manager 226 can collaboratively allow a non-technical user to react to or edit the content page based on user preferences. This feature is useful for the WCMS or ECMS, in which a user who has less technical knowledge can access the WCMS or ECMS to change content on a page.

In various embodiments, user input interface 228 and editing manager 226 also allow a user to insert new components to a content page or change the configurations of a component. As an example, client 220 receives and presents a content page with only base design, such as a simple grid layout with primitive components. A user, in this case, adds a component, e.g., an image, to the grid layout, e.g., by dragging and dropping the image to a desired location on the grid. Further, the user changes the configurations of the image, e.g., change its column width from two columns to three columns. The user can make such changes via user input interface 228 in many different ways. As an example, the user can use the property window associated with the component. As another example, the user can just drag the component to enlarge its size, such as its column width. The updated information of the component may be saved under a selected breakpoint.

The user input interface 228 and editing manager 226 may also allow a user to change the configurations of the grid layout, such as changing the number of columns in the grid or adding a nested grid to the grid. In various embodiments, user input interface 228 can enable a user to select a breakpoint for editing or use the default breakpoint. As an example, a user clicks on a tablet breakpoint via user input interface 228, then presentation manager 224 will simulate a tablet display environment. The user may then decide the number of columns in a grid and dynamically change the grid to the desired number of columns, e.g., changed via the property window of the grid. The user may similarly change other properties of the grid, such as insert or modify a nested grid in the grid.

In this way, user input interface 228 and editing manager 226 also allow a user to mutate the grid layout of a content page based on the selected breakpoint as the user changes the grid layout itself or the components inside the grid. For example, the user can set ten columns for a grid under a laptop breakpoint, but set five columns for the same grid under a tablet breakpoint. Thus, the grid will mutate depending on its computing environment.

In some embodiments, nested grids can be used to properly align components in a grid. As an example, a user wants to place a component directly beneath another component. In this case, the user can insert a nested grid to the host grid and place the two components into the nested grid to accomplish this purpose.

In various embodiments, networking interface 212 or networking interface 222 will enable content server 210 and client 220 to communicate with each other, e.g., utilize one or more wireless or wired networks. These wireless or wired networks may include public and/or private networks, such as, but not limited to, LANs, WANs, or the Internet. In some embodiments, these wireless networks may include one or more WPANs, WLANs, WMANs, or WWANs. In some embodiments, these wireless networks may include cellular networks, for example, Wideband Code Division Multiple Access (WCDMA), Global System for Mobile Communications (GSM), Long Term Evolution (LTE), and the like.

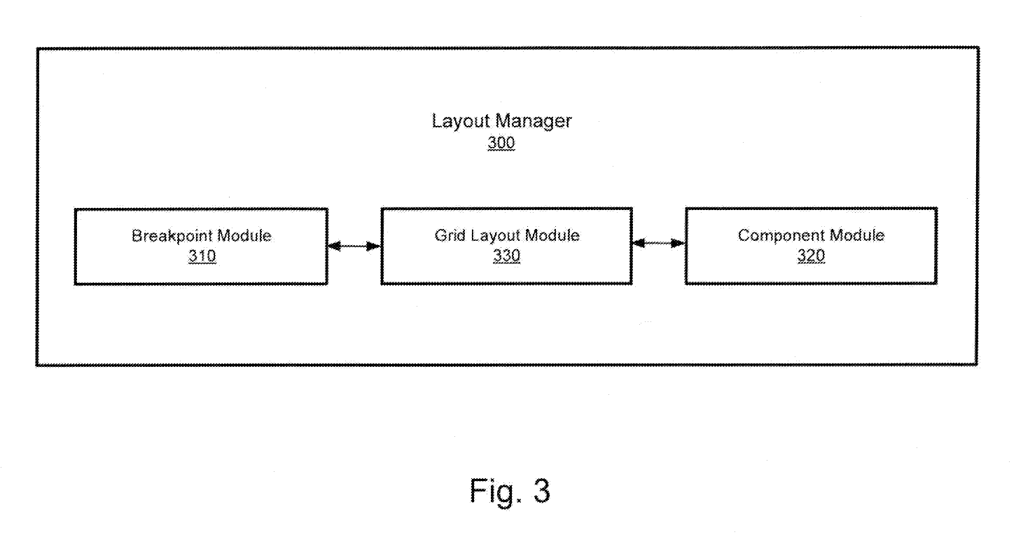

As can be appreciated, content server 210 and client 220 may be implemented differently than depicted in FIG. 2. As an example, content manager 214 can be combined with layout manager 216 to form a comprehensive module to generate grid layouts for content pages. In some embodiments, components depicted in FIG. 2 can have a direct or indirect connection not shown in FIG. 2. In some embodiments, some of the components depicted in FIG. 2 may be divided into multiple modules, such as what is illustrated in FIG. 3. Further, one or more components of content server 210 may be located across any number of different devices or networks. As an example, data store 218 may be implemented as an integrated subsystem of a data server rather than located in content server 210.

Referring now to FIG. 3, a schematic diagram illustrates an example implementation of layout manager 300 for managing grid layouts in accordance with various embodiments. In various embodiments, layout manager 300 includes breakpoint module 310, component module 320, and grid layout module 330 to generate grid layouts with mutable columns.

Breakpoint module 310 produces and manages various breakpoints associated with a content page. In some embodiments, breakpoint module 310 can insert one or more media query declarations into the content page to specify, e.g., the layouts for requesting devices with different characteristics, so that the content page will be provided to users with a localized layout to consume the information. In some embodiments, breakpoint module 310 can produce various breakpoints based on the display size. The size of a screen generally is described by the length of its diagonal, which is the distance between opposite corners. In an example, different breakpoints are defined for small phone-like devices, medium tablet-like devices, and large laptop-like devices. In some embodiments, breakpoint module 310 produces various breakpoints based on the logical image size, which describes the display resolution on a screen and may be measured in pixels, e.g., 1,920×1,080 for a 1080p television monitor or 1920×1200 for a WUXGA computer monitor. In some embodiments, breakpoint module 310 produces various breakpoints further based on the orientation of the layout, such as portrait or landscape. In other embodiments, breakpoint module 310 produces various breakpoints based on other characteristics of the displaying devices, such as the geographical location of the displaying device or the subscription/service level associated with the displaying device, just to name a few examples.

Component module 320 manages various properties of a component, but may also relate the component with selected breakpoints. A component in a content page can be in the form of text, image, audio, video, etc. A component within a grid or a nested grid can react on a selected breakpoint. As an example, the component is to be rendered with different width under different breakpoints, e.g., by changing the number of columns occupied by the component. As another example, the component is to be associated with special behavior under a selected breakpoint. Special behavior for the component may include preventing the component from being displayed under a selected breakpoint, or enforcing/disabling a line break for the component under another selected breakpoint. Special behavior for the component may also include placing the component into a nested grid under a selected breakpoint, so that, e.g., the component can be aligned in a particular manner.

In some embodiments, the relationship between a component and a selected breakpoint or the behavior of a component under a selected breakpoint can be stored with the component, e.g., by component module 320, into a resource node, e.g., in a database. When the component is retrieved next time, its associated behavioral information can be retrieved together with the component.

Grid layout module 330 manages various properties of a grid layout, and can also relate the grid layout with selected breakpoints. A grid layout can mutate based on predefined breakpoints. In some embodiments, the number of columns defined by a grid is to change based on the activated breakpoint. In some embodiments, nested grids is to be added, deleted, or modified based on the activated breakpoint. In some embodiments, directives for a new line break are to be added, removed, or modified based on the activated breakpoint.

When grid layout module 330 adds a nested grid into a host grid, the nested grid can intelligently inherit the allocated columns. For instance, if the host grid of 12 columns has a nested grid with the width of 4 columns, then the space allocated by the nested grid will not be divided again by 12 columns, but by 4 columns only. In some embodiments, a forced configuration can break out of this inheritance and enforce a different number of columns for the nested grid. For instance, continue with the previous example, the nested grid can be divided into 18 columns in the space of the 4 columns allocated from the host grid. In one embodiment, more columns will facilitate the nested grid to place more components in a same line.

In some embodiments, the relationship between a grid layout and a selected breakpoint or the behavior of a grid layout under a selected breakpoint can be stored with the grid layout, e.g., by grid layout module 330, into a resource node, e.g., in a database. When the component is retrieved next time, its associated behavioral information can be retrieved together with the component.

In some embodiments, the relationship among a component, a grid layout, and a selected breakpoint is to be stored together in a resource node, e.g., in a database. As an example, a resource node, e.g., data store 218 of FIG. 2, can specify an image to be placed in a nested grid under a portrait tablet breakpoint.

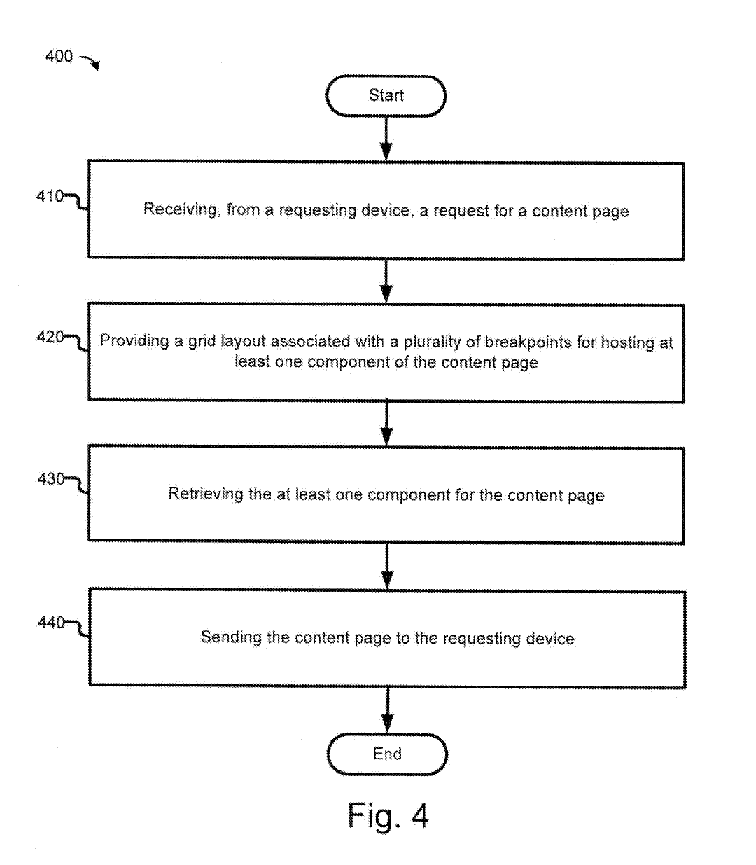

Referring now to FIG. 4, FIG. 4 is a flow diagram of an example process 400 for generating grid layouts, which may be practiced by an example apparatus in accordance with various embodiments. Process 400 may be performed by processing logic that comprises hardware (e.g., circuitry, dedicated logic, programmable logic, microcode, etc.), software (e.g., instructions run on a processing device to perform hardware simulation), or a combination thereof. The processing logic is to be configured to generate grid layouts. As such, process 400 may be performed by a computing device, e.g., content server 210, to implement one or more embodiments of the present disclosure. In various embodiments, process 400 can have fewer or additional operations, or perform some of the operations in different orders.

In various embodiments, the process begins at block 410, where a request for a content page is received by a computing device, e.g., by content server 210 of FIG. 2 or content server 162 of FIG. 1. In various embodiments, the content page can be accessed by various requesting devices via a common URL regardless of the specific characteristics of the underlying requesting device. As an example, a user needs to access the inventory of a wholesaler via a desktop computer as well as a smartphone, which has a very different screen size or screen resolution from the desktop computer.

Next, at block 420, the computing device generates a grid layout with various breakpoints and mutable columns for at least one breakpoint, for hosting a component of the content page, e.g., by layout manager 216 of FIG. 2 or layout manager 300 of FIG. 3. In various embodiments, various breakpoints represent various display settings of the potential requesting devices. In various embodiments, the grid layout is to be rendered differently under different breakpoints, as discussed previously, e.g., the number of columns of the grid can mutate according to the selected breakpoint.

In some embodiments, a nested grid layout can be enabled in the host grid layout, e.g., by embedding a nested grid inside the host grid. The nested grid generally inherits one or more properties associated with the mutable columns of the host grid, e.g., the number of columns as discussed herein. In some embodiments, the relative position of the component among a group of components to be displayed on the grid layout can be specified, e.g., by layout manager 216 of FIG. 2 or layout manager 300 of FIG. 3. Thus, the various components in a content page can be afloat and can be pushed in a predefined direction inside the boundary of the grid, e.g., from left to right and from top to bottom.

In some embodiments, an indication can be provided with the grid layout to prevent a component from being displayed on the grid layout for a selected breakpoint, so that the component will be hidden from one breakpoint, but be displayed in another breakpoint. In some embodiments, an indication can be provided with the grid layout to force a component to be displayed on a new line on the grid layout for a selected breakpoint, so that the component will be saliently displayed in the beginning of a line or the leftmost location in the grid.

Next, at block 430, the component for the content page will be retrieved. In some embodiments, the component may be represented by a URL, and the component can be retrieved locally in a server serving the content page or remotely from another computing device. In some embodiments, relevant information of the component will also be retrieved, such as the number of columns occupied by the component under a selected breakpoint. Thus, the content page can enable the same component to mutate under different breakpoints.

Next, at block 440, the content page with the grid layout and the component will be sent to the requesting device. In some embodiments, a media query declaration for various breakpoints will be sent in the content page to indicate the predefined breakpoints associated with the content page. In some embodiments, a style sheet can be sent to enable the requesting device to render the content page based on a selected breakpoint and the grid layout.

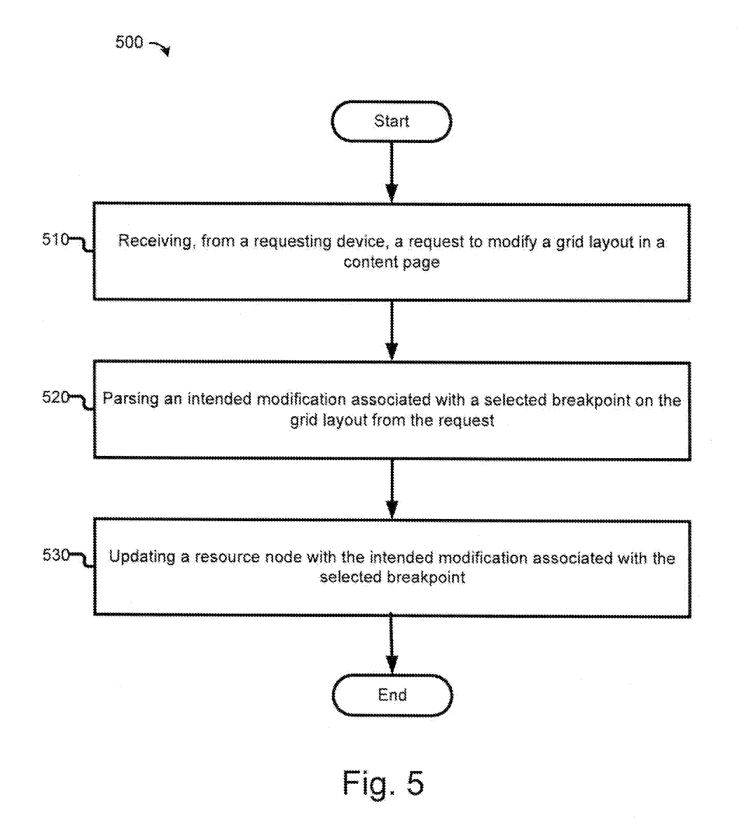

Referring now to FIG. 5, FIG. 5 is a flow diagram of an example process 500 for updating grid layout, which may be practiced by an example apparatus in accordance with various embodiments. As shown, process 500 may be performed by content server 210 of FIG. 2 to implement one or more embodiments of the present disclosure. Similar to process 400, in various embodiments, process 500 can have fewer or additional operations, or perform some of the operations in different orders.

In various embodiments, process 500 begins at block 510, where a computing device receives a request to modify a component in a content page from a requesting device. In some embodiments, the request can be included in an HTTP Post message.

Process 500 continues at block 520, where the computing device parses an intended modification associated with a selected breakpoint on the grid layout from the request. In some embodiments, the computing device parses an intended number of columns occupied by a component associated with the selected breakpoint on the grid layout from the request. In some embodiments, the computing device parses from the request an intended number of columns associated with the selected breakpoint inside the grid layout. In some embodiments, the computing device parses, from the request, one or more characteristics of a nested grid inside the grid layout. In some embodiments, the computing device parses, from the request, a relative position of a component among some related components to be displayed on the grid layout associated with the selected breakpoint. In some embodiments, the computing device parses, from the request, an indication for preventing a component from being displayed on the grid layout under a selected breakpoint. In some embodiments, the computing device parses, from the request, an indication for forcing a component to be displayed on a new line on the grid layout under a breakpoint.

Next, process 500 continues to block 530, where the computing device updates a resource node that corresponds to the intended modification associated with the selected breakpoint. Thus, in some embodiments, the computing device updates the resource node with the intended number of columns occupied by a component associated with the selected breakpoint or with the intended number of columns associated with a grid layout under the selected breakpoint. In some embodiments, the computing device updates a grid layout with a nested grid, e.g., inserting, removing, or modifying the nested grid. In some embodiments, the computing device updates a grid layout associated with the selected breakpoint with the relative position of the component, e.g., the component may be moved to a different position. In some embodiments, the computing device updates a grid layout with the indication for preventing a component from being displayed or forcing a component to be displayed on a new line.

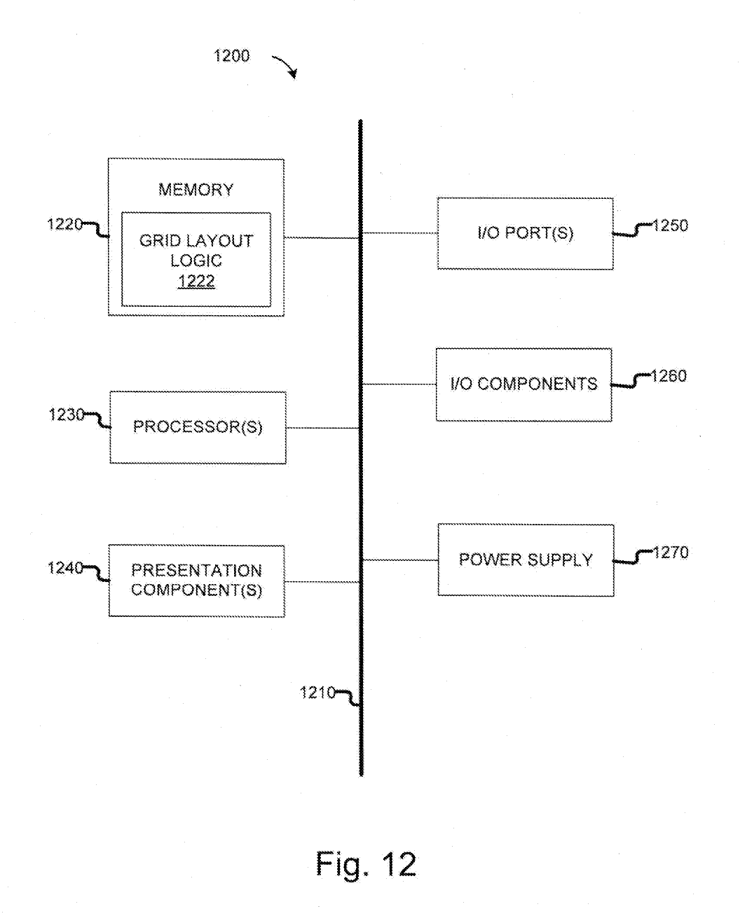

Having briefly described an overview of embodiments of the present invention, an exemplary operating environment in which embodiments of the present invention may be implemented is described below in order to provide a general context for various aspects of the present invention. Referring initially to FIG. 12 in particular, an exemplary operating environment for implementing embodiments of the present invention is shown and designated generally as computing device 1200. Computing device 1200 is but one example of a suitable computing environment and is not intended to suggest any limitation as to the scope of use or functionality of the invention. Neither should the computing device 1200 be interpreted as having any dependency or requirement relating to any one or combination of components illustrated.

The invention may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The invention may be practiced in a variety of system configurations, including hand-held devices, consumer electronics, general-purpose computers, more specialty computing devices, etc. The invention may also be practiced in distributed computing environments where tasks are performed by remote-processing devices that are linked through a communications network.

With reference to FIG. 12, computing device 1200 includes a bus 1210 that directly or indirectly couples the following devices: memory 1220, one or more processors 1230, one or more presentation components 1240, input/output (I/O) ports 1250, input/output components 1260, and an illustrative power supply 1270. Bus 1210 represents what may be one or more busses (such as an address bus, data bus, or combination thereof). Although the various blocks of FIG. 12 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventor recognizes that such is the nature of the art, and reiterates that the diagram of FIG. 12 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 12 and reference to “computing device.”

Computing device 1200 typically includes a variety of computer-readable media. Computer-readable media can be any available media that can be accessed by computing device 1200 and includes both volatile and nonvolatile media, and removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 1200. Computer storage media does not comprise signals per se. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 1220 includes computer-storage media in the form of volatile and/or nonvolatile memory. The memory may be removable, non-removable, or a combination thereof. Exemplary hardware devices include solid-state memory, hard drives, optical-disc drives, etc. Computing device 1200 includes one or more processors that read data from various entities such as memory 1220 or I/O components 1260. Presentation component(s) 1240 present data indications to a user or other device. Exemplary presentation components include a display device, speaker, printing component, vibrating component, etc.

In various embodiments, memory 1220 includes, in particular, temporal and persistent copies of grid layout logic 1222. Grid layout logic 1222 includes instructions that, when executed by one or more processors 1230, result in computing device 1200 providing automatically generated grid layout, such as, but not limited to, process 400; or enabling a grid layout to be modified, such as, but not limited to, process 500. In various embodiments, grid layout logic 1222 includes instructions that, when executed by processor 1210, result in computing device 1200 performing various functions associated with, such as, but not limited to, content manager 214, layout manager 216, editing manager 226, presentation manager 224, or user input interface 228, in connection with FIG. 2. In various embodiments, grid layout logic 1222 includes instructions that, when executed by processor 1230, result in computing device 1200 performing various functions associated with, such as, but not limited to, breakpoint module 310, grid layout module 330, or component module 320, in connection with FIG. 3.

In some embodiments, one or more processors 1230 may be packaged together with grid layout logic 1222. In some embodiments, one or more processors 1230 may be packaged together with grid layout logic 1222 to form a System in Package (SiP). In some embodiments, one or more processors 1230 can be integrated on the same die with grid layout logic 1222. In some embodiments, processor 1210 can be integrated on the same die with grid layout logic 1222 to form a System on Chip (SoC).

I/O ports 1250 allow computing device 1200 to be logically coupled to other devices including PO components 1260, some of which may be built in. Illustrative components include a microphone, joystick, game pad, satellite dish, scanner, printer, wireless device, etc. The I/O components 1260 can also provide a natural user interface (NUI) that processes air gestures, voice, or other physiological inputs generated by a user. In some embodiments, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 1200. The computing device 1200 may be equipped with depth cameras, such as stereoscopic camera systems, infrared camera systems, RGB camera systems, touchscreen technology, and combinations of these, for gesture detection and recognition. Additionally, the computing device 1200 may be equipped with accelerometers or gyroscopes that enable detection of motion. The output of the accelerometers or gyroscopes may be provided to the display of the computing device 1200 to render immersive augmented reality or virtual reality.

Although certain embodiments have been illustrated and described herein for purposes of description, a wide variety of alternate and/or equivalent embodiments or implementations calculated to achieve the same purposes may be substituted for the embodiments shown and described without departing from the scope of the present disclosure. This application is intended to cover any adaptations or variations of the embodiments discussed herein. Therefore, it is manifestly intended that embodiments described herein be limited only by the claims.

An abstract is provided that will allow the reader to ascertain the nature and gist of the technical disclosure. The abstract is submitted with the understanding that it will not be used to limit the scope or meaning of the claims. The following claims are hereby incorporated into the detailed description, with each claim standing on its own as a separate embodiment.

What is claimed is:

1. A computer-implemented method, comprising:
receiving, from a requesting device, a request for a content page;
generating a grid layout for hosting at least one component of the content page, the grid layout being associated with a plurality of breakpoints and having mutable columns that are mutable based on one of the plurality of breakpoints that corresponds with the requesting device;
obtaining the at least one component for the content page; and
providing the content page with the grid layout and the at least one component to the requesting device.

2. The method of claim 1, wherein the grid layout comprises a nested grid in the grid layout, the nested grid inheriting at least a property associated with the mutable columns.

3. The method of claim 1, wherein the one of the plurality of breakpoints corresponds with a first number of columns for the grid layout and another of the plurality of breakpoints corresponds with a second number of columns that is different from the first number of columns.

4. The method of claim 1, wherein the plurality of breakpoints represent a plurality of display settings.

5. The method of claim 1, wherein the obtaining further comprises obtaining a number of columns occupied by the at least one component, the number of columns corresponding to the one of the plurality of breakpoints.

6. The method of claim 1, wherein an indication of a relative position of one of the at least one components among a plurality of components to be displayed on the grid layout is provided with the grid layout.

7. The method of claim 1, wherein an indication to prevent one of the at least one components from being displayed on the grid layout or an indication to display one of the at least one components on a new line of the grid layout is provided with the grid layout.

8. The method of claim 1, wherein the providing comprises providing a style sheet to enable the requesting device to render the content page based on the one of the plurality of breakpoints and the grid layout.

9. A system, comprising:
a networking interface to receive a request for a content page;
a content manager, coupled to the networking interface, to retrieve a plurality of components for the content page based on the request; and
a layout manager, coupled to the content manager and the networking interface, to provide a grid layout associated with a plurality of breakpoints and mutable columns that are mutable based on a selected one of the plurality of breakpoints, to host the plurality of components.

10. The system of claim 9, wherein the content manager further retrieves a number of columns occupied by a component of the plurality of components associated with the selected one of the plurality of breakpoints.

11. The system of claim 9, wherein the layout manager further provides a nested grid layout, nested in the grid layout, the nested grid layout inheriting at least a property associated with the mutable columns.

12. The system of claim 9, wherein the layout manager further provides a relative position of a component among the plurality of components to be displayed on the grid layout.

13. The system of claim 9, wherein the layout manager further provides an indication to prevent a component among the plurality of components from being displayed on the grid layout for the selected one of the plurality of breakpoints.

14. The system of claim 9, wherein the layout manager further provides an indication to force a component among the plurality of components to be displayed on a new line on the grid layout for the selected one of the plurality of breakpoints.

15. A computer-implemented method, comprising:
receiving, from a requesting device, a request to modify a grid layout in a content page;
parsing an intended modification of the grid layout corresponding with a selected breakpoint from the request; and
updating a resource node with the intended modification under the selected breakpoint.

16. The method of claim 15, further comprising:
parsing, from the request, an intended number of columns occupied by a component under the selected breakpoint on the grid layout from the request; and
updating the resource node with the intended number of columns occupied by the component under the selected breakpoint.

17. The method of claim 15, further comprising:
parsing, from the request, an intended number of columns associated with the selected breakpoint inside the grid layout; and
updating the resource node with the intended number of columns associated with the selected breakpoint.

18. The method of claim 15, further comprising:
parsing, from the request, a plurality of characteristics of a nested grid inside the grid layout; and
updating the resource node with the nested grid.

19. The method of claim 15, further comprising:
parsing, from the request, a relative position of a component among a plurality of components to be displayed on the grid layout associated with the selected breakpoint; and
updating the resource node associated with the selected breakpoint with the relative position of the component.

20. The method of claim 15, further comprising:
parsing, from the request, a first indication, associated with the selected breakpoint, for preventing the component from being displayed on the grid layout, or a second indication, associated with the selected breakpoint, to force the component to be displayed on a new line on the grid layout; and
updating the resource node with the first or second indication.
